(19) United States
(12) Patent Application Publication
(10) Pub. No.: US 2008/0008935 A1
(43) Pub. Date: Jan. 10, 2008

(54) Case Structure for a Lithium Secondary Battery

(76) Inventor: Donald P.H. Wu, Hsin-Feng Hsiang (TW)

Correspondence Address: Dr. BANGER SHIA, 102 Lindencrest Ct, Sugar Land, TX, 77479-5201, US

(21) Appl. No.: 11/456,127

(22) Filed: Jul. 7, 2006

(51) Int. Cl. H01M 2/04; H01M 2/02

(52) U.S. Cl. 429/175; 429/176

(57) ABSTRACT

A case structure for a lithium secondary battery comprises a plurality of threaded holes formed in the annular flange of the case, and the cap is correspondingly formed with a plurality of inserting holes. The cap is fitted at the open ends of the case in such a manner that the inserting holes of the cap are aligned with the threaded holes of the case. Therefore, the case can be hermetically sealed by the cap without using laser welding or complicated precision operation, substantially saving the production cost. Furthermore, the structural design of the present invention allows the battery interior components to be replaced or repaired easily by unscrewing the cap without breaking the battery.

### BACKGROUND OF THE INVENTION

1. Field of the Invention

The present invention relates to case structure for a lithium secondary battery, and more particularly to the structure for sealing the open end of the lithium secondary battery case.

2. Description of the Prior Art

Referring to FIG. 1, a conventional lithium secondary battery disclosed in U.S. Pat. No. 5,849,431 comprises a hollow case 10 in which are received an electrode assembly 11, a core 12, a plurality of leads 13, two battery terminals 14, two nuts 15 and two caps 16. The electrode assembly 11 winds about the core 12, the plurality of leads extending from the electrode assembly 11 are welded to the outer periphery of the battery terminals 14. Each of the battery terminals 14 has a screw rod 141 inserted through a through hole 161 of the caps 16 and screwed thereto by the nuts 15, so that the battery terminals 14 are closely pressed against the caps 16. Finally, the upper and lower open ends 101 of the case 10 are sealed with the two caps 16, and the caps 16 are fixed to the case 10 by laser welding.

It is to be noted that the caps and the case are jointed by laser welding. The laser welding equipment and the weld operation must be very precise, otherwise, apertures that are invisible to the naked eye are likely to appear between the two caps and the case, and the electrolyte will leak out of the case, resulting in unrecoverable failures.

In addition, the caps cannot be removed from the case since they are jointed by laser welding. Therefore, it has to break the battery case when the interior components thereof need to be replaced or repaired.

The present invention has arisen to mitigate and/or obviate the afore-described disadvantages.

### SUMMARY OF THE INVENTION

The primary objective of the present invention is to provide a case structure for a lithium secondary battery, wherein a plurality of threaded holes is formed in the annular flange of the case, and the cap is correspondingly formed with a plurality of inserting holes. The cap is fitted at the open ends of the case in such a manner that the inserting holes of the cap are aligned with the threaded holes of the case. Therefore, the case can be hermetically sealed by the cap without using laser welding or complicated precision operation, substantially saving the production cost.

Another objective of the present invention is to provide a case structure for a lithium secondary battery, the structural design of the present invention allows the battery interior components to be replaced or repaired easily by unscrewing the cap without breaking the battery.

### BRIEF DESCRIPTION OF THE DRAWINGS

FIG. 1 is a cross sectional view of showing a case structure of a lithium secondary battery disclosed in U.S. Pat. No. 5,849,431;

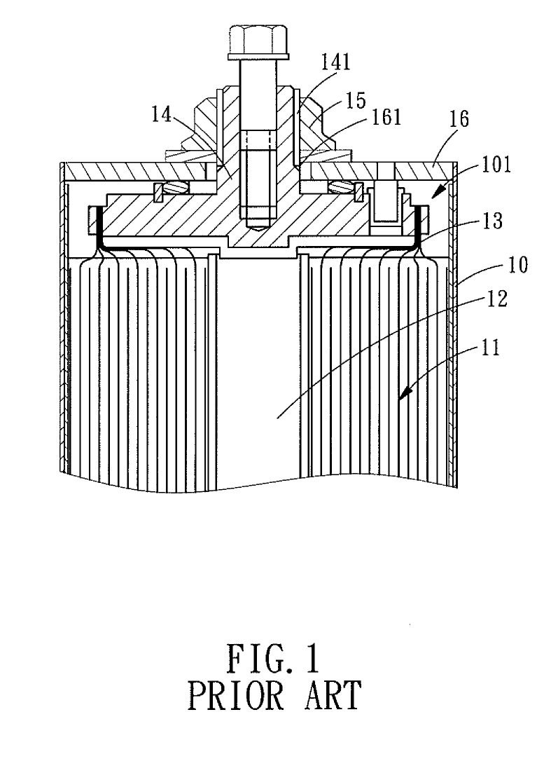

FIG. 2 is an exploded view of showing the case structure of a lithium secondary battery in accordance with the present invention;

FIG. 3 is a cross sectional view of the case structure of the lithium secondary battery in accordance with the present invention;

FIG. 4 is a cross sectional view of the case structure of a lithium secondary battery in accordance with another embodiment of the present invention; and

FIG. 5 is a cross sectional view of the case structure of a lithium secondary battery in accordance with another embodiment of the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

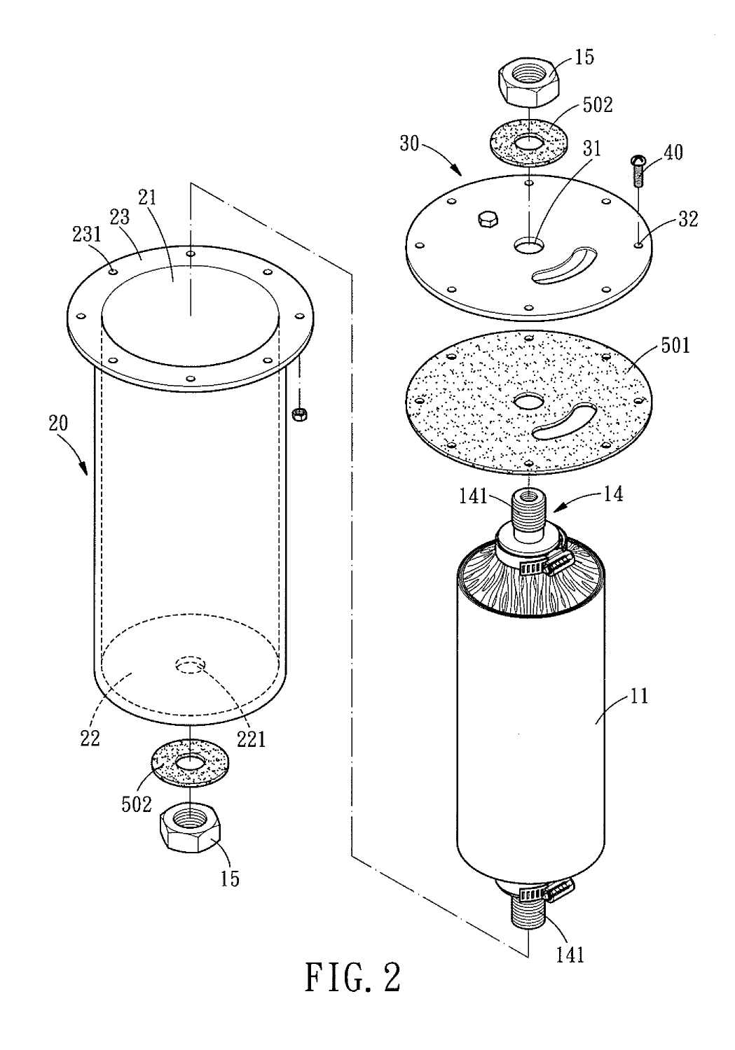

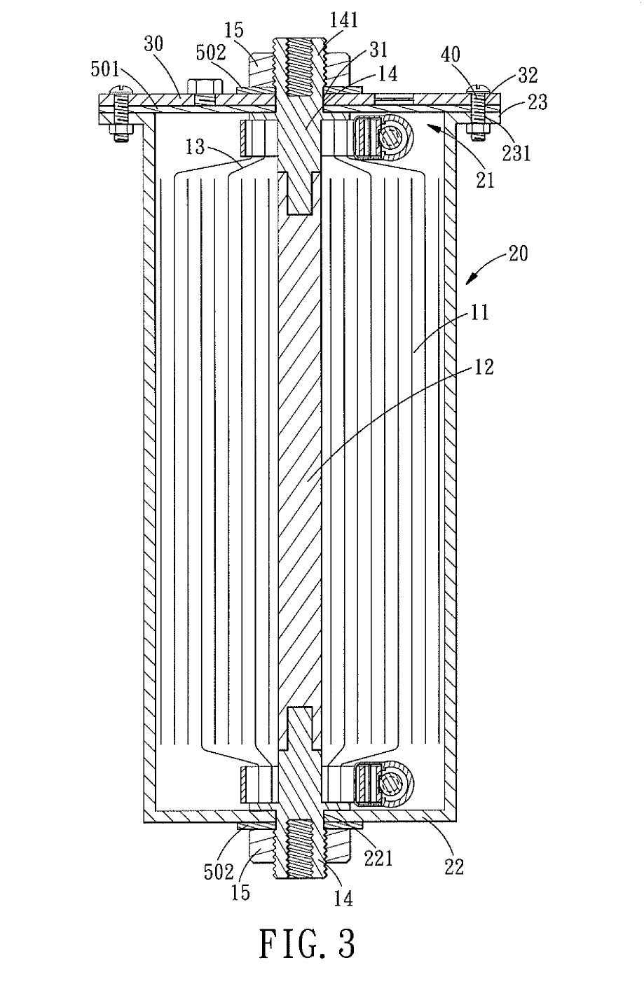

Referring to FIGS. 2 and 3, a case structure for a lithium secondary battery in accordance with the present invention is provided for accommodation of the battery components. The case 20 has an open end sealed with a cap, and the cap is fixed thereon by screws.

The case 20 is a hollow structure having an open end 21 and a close end 22. A through hole 221 is formed in the close end 22. The case 20 is provided for accommodation of battery components: such as: electrode assembly 11, core 12, battery terminal 14 and nut 15. The battery terminal 14 protrudes out of the through hole 221. An annular flange 23 is formed at the outer periphery of the open end 21 of the case 20, and a plurality of threaded holes 231 is formed in the annular flange 23.

The cap 30 is formed with a through hole 31 for allowing the battery terminal 14 to protrude out of the case 20. The nut 15 serves to fix the cap 30 to the battery terminal 14. A plurality of inserting hole 32 is formed in the cap 30, the cap 30 is used to cover the open end 21 of the case 20, and the inserting holes 32 of the cap 30 are aligned with the threaded holes 231 of the case 20.

The screws 40 are screwed through the inserting holes 32 of the cap 30 and into the threaded holes 231 of the case 20, so that the case 20 is sealed with the cap 30, forming an airtight case.

The battery case structure of the present invention is so simple that the cap can hermetically seal the case without the use of laser welding.

For a better understanding of the present invention, its operation and function, reference should be made to FIGS. 2 and 3 again. The plurality of threaded holes 231 are annularly formed in the annular flange 23 of the case 20, and the plurality of inserting holes 32 are formed in the cap 30. When installing the battery components and fixing the cap 30 to the open end 21 of the case 20, the battery components, such as the electrode assembly 11 can be fitted into the case 20 via the open end 21, and an end of the battery terminal 14 protrudes out of the through hole 221 of the case 20. And then, the cap 30 covers the open end 21 of the case 20, the threaded hole 231 are aligned with the inserting holes 32, the screws 40 are screwed through the inserting holes 32 of the 30 and into the threaded holes 231. In this way, the open end 21 of the case 20 is sealed with the cap 30. Another end of the battery terminal 14 is protruded out of the through hole 31 of the cap 30. The case 20 can be hermetically sealed without using laser welding or complicated precision operation, substantially saving the production cost.

It is to be noted that in order to ensure the hermetical effect of the case 20 after it is sealed with the cap 30, a leak-proof washer 501 can be disposed on the annular flange 23, so that the annular flange 23 of the case 20 will be hermetically pressed against the inner surface of the cap 30 after the cap 30 is screwed to the open end 21 of the case 20. Furthermore, another leak-proof washer 502 can also be arranged between the nut 15 and the through hole 31 of the cap 30 and between the nut 15 and the through hole 221 of the close end 22 of the case 20, so as to provide a hermetical effect between the nuts 15 and the through holes 221 and 31. In addition, the annular flange 23 can be coated with sealing glue for ensuring the hermetical effect between the cap 30 and the case 20.

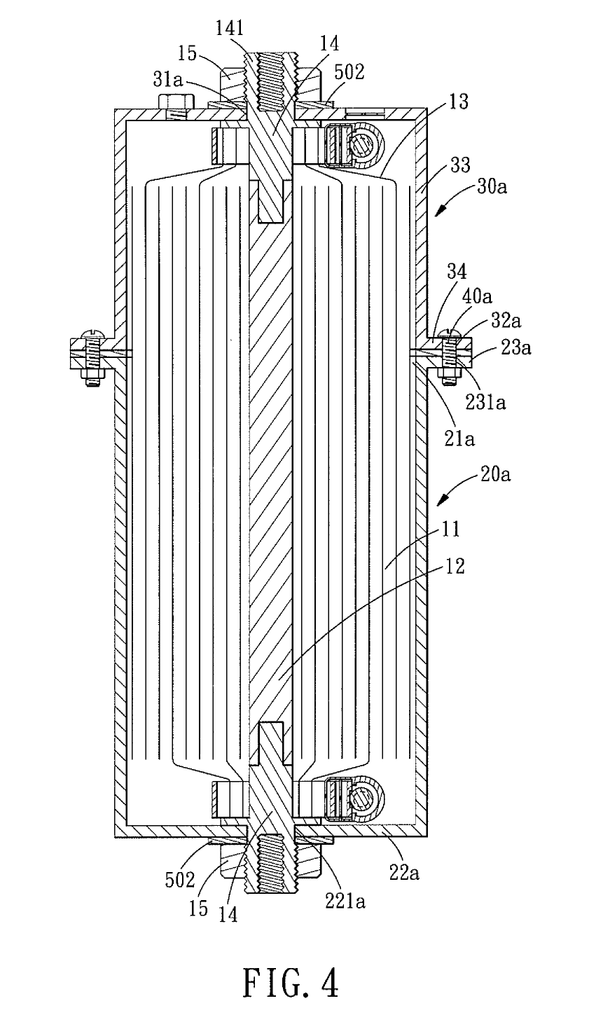

FIG. 4 shows a second embodiment of the present invention, wherein the case 20a is a hollow structure having an open end 21a and a close end 22a. A through hole 221a is formed in the close end 22a for allowing the battery terminal 14 to protrude out of the case 20a. An annular flange 23a is formed at the outer periphery of the open end 21a of the case 20a, and a plurality of threaded holes 231 is formed in the annular flange 23. An annular wall 33 vertically extends from the outer periphery of the cap 30a, and a connecting flange 34 is formed at the outer periphery of the annular wall 33, annularly formed in the connecting flange 34 is a plurality of inserting holes 32a. The cap 30a is fitted at the open end 21a of the case 20a in such a manner that the inserting holes 32a of the cap 30a are aligned with the threaded holes 231a of the case 20a, the screws 40a are screwed through the inserting holes 32a of the cap 30a and into the threaded holes 231a of the case 20a. In this way, the cap 30a is assembled to the case 20a, forming a hermetical battery case, and the battery components are allowed to protrude out of the through holes 221a, 31a of the close end 22a and the cap 30a.

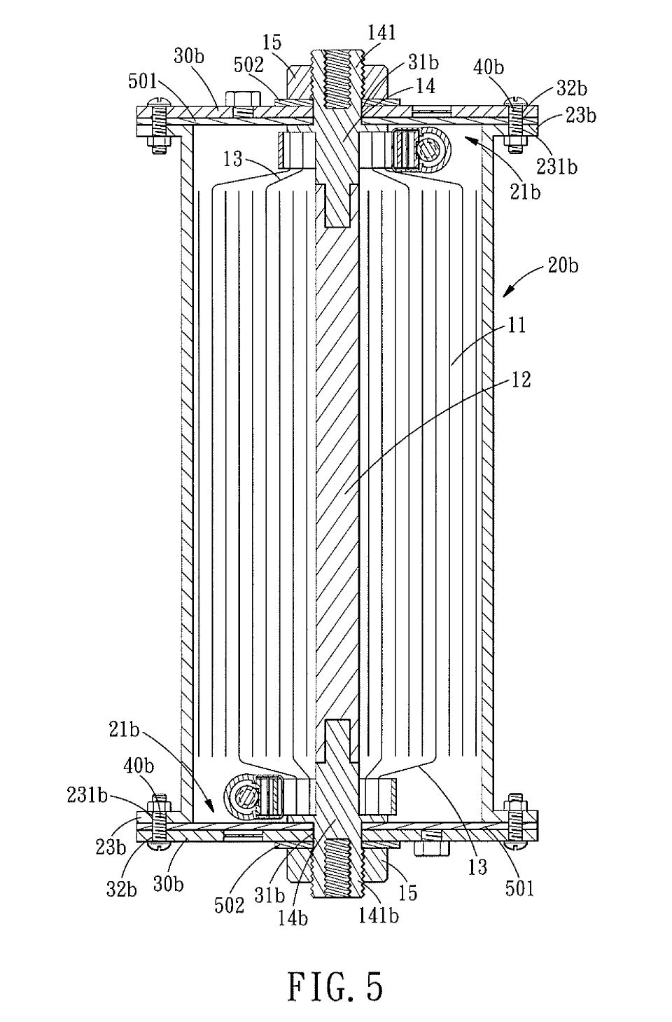

In addition to the abovementioned structure that is formed by a single cap and a case, as shown in FIG. 5, the case structure can also be provided with two caps. The case 20b has two open ends 21b, each of which is formed on the outer periphery thereof with an annular flange 23b, and a plurality of threaded holes 231b is annularly formed in the annular flange 23b. Each of the caps 30b is formed with a through hole 31b through which the battery terminal 14 is protruded out of the case 20b. The screws 15 serve to fix the caps 30b to the battery terminal 14, and a plurality of inserting holes 32b is formed in the outer periphery of the respective caps 30b. Each of the caps 30b is fitted at the open ends 21b of the case 20b in such a manner that the inserting holes 32b of the cap 30b are aligned with the threaded holes 231b of the case 20b, the screws 40b are screwed through the inserting holes 32b of the cap 30b and into the threaded holes 231b of the case 20b. In this way, the cap 30b is assembled to the case 20b, forming a hermetical battery case.

It is to be noted that the structural design of the present invention allows the battery interior components to be replaced or repaired easily by unscrewing the cap instead of breaking the battery.

While we have shown and described various embodiments in accordance with the present invention, it is clear to those skilled in the art that further embodiments may be made without departing from the scope of the present invention.

What is claimed is:

1. A case structure for a lithium secondary battery comprising:
a case being a hollow structure having an open end and a close end, a through hole formed in the close end, an annular flange formed at an outer periphery of the open end of the case, and a plurality of threaded holes formed in the annular flange;
a cap formed with a through hole, a plurality of inserting holes formed in an outer periphery of cap, the cap being fitted at the open end of the case in such a manner that the inserting holes of the cap are aligned with the threaded holes of the case; and
a plurality of screws being screwed through the inserting holes of the cap and into the threaded holes of the case, so that the case is hermetically sealed with the cap, forming an airtight case.

2. The case structure for a lithium secondary battery as claimed in claim 1, wherein a leak-proof washer is disposed on the annular flange of the case, so that the annular flange of the case will be hermetically pressed against the inner surface of the cap after the cap is screwed to the open end of the case.

3. A case structure for a lithium secondary battery comprising:
a case being a hollow structure having an open end and a close end, a through hole formed in the close end, an annular flange formed at an outer periphery of the open end of the case, and a plurality of threaded holes formed in the annular flange;
a cap formed with a through hole, an annular wall vertically extending from an outer periphery of the cap, and a connecting flange formed at an outer periphery of the annular wall, a plurality of inserting holes annularly formed in the connecting flange, the cap being fitted at the open end of the case in such a manner that the inserting holes of the cap are aligned with the threaded holes of the case; and
a plurality of screws being screwed through the inserting holes of the cap and into the threaded holes of the case, so that the case is hermetically sealed with the cap, forming an airtight case.

4. A case structure for a lithium secondary battery comprising:
a case being a hollow structure having two open ends, an annular flange formed at an outer periphery of the respective open end of the case, and a plurality of threaded holes formed in the annular flange;
two caps each being formed with a through hole for allowing interior battery components to protrude out of the case, a plurality of inserting holes annularly formed in an outer periphery of the respective caps, the caps being fitted at the open ends of the case in such a manner that the inserting holes of the cap are aligned with the threaded holes of the case; and
a plurality of screws being screwed through the inserting holes of the cap and into the threaded holes of the case, so that the case is hermetically sealed with the cap, forming an airtight case.
